(19) United States
(12) Patent Application Publication
(10) Pub. No.: US 2026/0321082 A1
(43) Pub. Date: Oct. 15, 2026

(54) ENTRANCE MANAGEMENT SYSTEM, ENTRANCE MANAGEMENT METHOD, AND NON-TRANSITORY COMPUTER-READABLE MEDIUM

(71) Applicant: NEC Corporation, Tokyo (JP)

(72) Inventor: Noritaka YAMASHITA, Tokyo (JP)

(73) Assignee: NEC Corporation, Tokyo (JP)

(21) Appl. No.: 19/639,561

(22) Filed: Apr. 6, 2026

(30) Foreign Application Priority Data
Apr. 10, 2025 (JP) 2025-064917

(51) Int. Cl. G07C 9/37; G06Q 10/02; G06V 40/16

(52) U.S. Cl. CPC G07C 9/37; G06Q 10/028; G06V 40/172

(57) ABSTRACT

Provided is an entrance management system or the like capable of easily issuing a group ticket and associating face images of a representative and a companion with the group ticket. An entrance management system includes a group ticket issuing unit for registering a face image of a representative and issuing a ticket of a group including the representative and a companion, a face authentication control unit for photographing a face image of the representative, executing face authentication based on the photographed face image of the representative and the registered face image, and permitting the representative to enter in successful face authentication, and a registration unit for photographing a face image of the companion, registering the photographed face image of the companion in association with a ticket of the group, and permitting the companion to enter.

### INCORPORATION BY REFERENCE

This application is based upon and claims the benefit of priority from Japanese patent application No. 2025-064917, filed on Apr. 10, 2025, the disclosure of which is incorporated herein in its entirety by reference.

### TECHNICAL FIELD

The present disclosure relates to an entrance management system, an entrance management method, and a program.

### BACKGROUND ART

There is a technique for performing identification confirmation and ticket validity confirmation using face authentication at the time of entering an event venue or the like. In a case where a group watches sports or enjoys an event, a representative (e.g., the father) may purchase tickets for all the members of the group (family) together.

PTL 1: WO 2023/013179 A1

### SUMMARY

In a case where identification confirmation of all the members of the group is performed using face authentication at the time of entering an event venue or the like, it is troublesome that the representative collects face images of all the members of the group in advance and associates not only the face image of the representative him/herself but also face information of the companion with the ticket.

The present disclosure has been made to solve such a problem, and an example object of the present disclosure is to provide an entrance management system or the like capable of easily issuing a group ticket and associating face images of a representative and a companion with the group ticket.

An entrance management system according to one example aspect of the present disclosure includes a group ticket issuing unit for registering a face image of a representative and issuing a ticket of a group including the representative and a companion, a face authentication control unit for photographing a face image of the representative, executing face authentication based on the photographed face image of the representative and the registered face image, and permitting the representative to enter in successful face authentication, and a registration unit for photographing a face image of the companion, registering the photographed face image of the companion in association with a ticket of the group, and permitting the companion to enter.

An entrance management method according to one example aspect of the present disclosure includes registering a face image of a representative and issuing a ticket of a group including the representative and a companion, photographing a face image of the representative, executing face authentication based on the photographed face image of the representative and the registered face image, and permitting the representative to enter in successful face authentication, and photographing a face image of the companion, registering the photographed face image of the companion in association with a ticket of the group, and permitting the companion to enter.

A program according to one example aspect of the present disclosure causes a computer to execute registering a face image of a representative and issuing a ticket of a group including the representative and a companion, photographing a face image of the representative, executing face authentication based on the photographed face image of the representative and the registered face image, and permitting the representative to enter in successful face authentication, and photographing a face image of the companion, registering the photographed face image of the companion in association with a ticket of the group, and permitting the companion to enter.

According to the present disclosure, an entrance management system or the like capable of easily issuing a group ticket and associating face images of a representative and a companion with the group ticket can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram describing a configuration of an entrance management system according to the present disclosure;

FIG. 2 is a flowchart illustrating an entrance management method according to the present disclosure;

FIG. 3 is a diagram describing a procedure in which a representative registers his/her own face image according to the present disclosure;

FIG. 4 is a diagram describing an example of group ticket information after purchase by a representative according to the present disclosure;

FIG. 5 is a diagram describing a procedure at the time of entry of a representative and a companion according to the present disclosure;

FIG. 6 is a diagram describing an example of group ticket information after a companion has entered according to the present disclosure;

FIG. 7 is a diagram describing a configuration and an operation of the entrance management system according to the present disclosure;

FIG. 8 is a diagram describing face authentication processing (successful identification confirmation) in a venue and a seat according to the present disclosure; and

FIG. 9 is a diagram describing face authentication processing (unsuccessful identification confirmation) in a venue and a seat according to the present disclosure.

### EXAMPLE EMBODIMENTS

Hereinafter, specific example embodiments to which the present invention is applied will be described in detail with reference to the drawings. However, the present invention is not limited to the following example embodiments. In order to clarify description, the following description and drawings are simplified as appropriate.

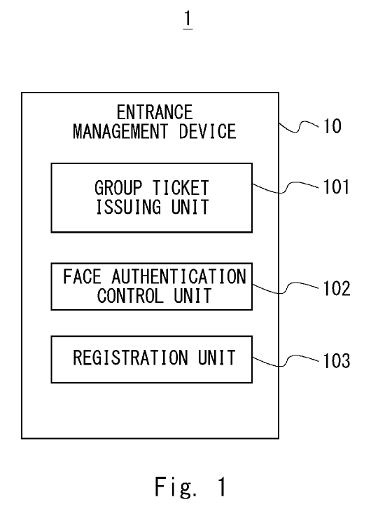

FIG. 1 is a block diagram describing a configuration of an entrance management system according to the present disclosure.

An entrance management system 1 issues a ticket for an event venue or a transportation means (e.g., an airplane, a bullet train, a passenger ship, etc.) in advance, and manages entrance to the venue or the transportation means by face authentication. Examples of the event include, but are not limited to, sports and entertainment fields such as sports spectating, theater going, movie watching, and concert. The entrance management system 1 is particularly used to facilitate ticket issuance and entrance management of a group including a plurality of persons such as family members and friends. The entrance management system 1 can include a ticket selling function, a face image registration function, and a face authentication function.

The entrance management system 1 is configured by one or more computers having a memory and a processor. A control unit of entrance management system 1 has a function of executing various controls based on various programs stored in the storage unit. The entrance management system 1 includes a group ticket issuing unit 101, a face authentication control unit 102, and a registration unit 103. At least some of these components may be executed in a distributed manner by another computer. In a case where the entrance management system 1 is configured by a single computer, the entrance management system 1 may also be referred to as an entrance management device 10.

The group ticket issuing unit 101 registers a face image of a representative (in entrance management system 1 by a terminal of the representative), and issues a ticket for a group including the representative and one or more companions. The group is, for example, a family, the representative is a father, and the one or more companions are a mother, a child, a grandfather, a grandmother, or the like, but is not limited thereto. The group may be a friend, colleague, club, or the like, and the representative may be at least one person who represents the group. The ticket here may be a paper ticket mailed or issued at a convenience store or the like, or may be an electronic e-ticket displayable on a mobile terminal such as a smartphone. The paper ticket may be mailed or issued to each of the representative and the companion. The e-ticket may be sent to each of the representative and the companion, for example, to each e-mail address, or may be displayed with an application of a mobile terminal of each of the representative and the companion.

The face authentication control unit 102 photographs a face image of the representative (e.g., by a camera of an authentication terminal installed in a venue), and executes face authentication based on the photographed face image of the representative and the registered face image. In the case of successful face authentication, the representative is permitted to enter. The face authentication method may use known methods, such as extracting feature portions of a face and contrasting matching points and difference points of the feature portions. As an admission method, the success of the face authentication may be simply returned from the entrance management device 20 to the authentication terminal installed in the venue, or a physical entrance control device that automatically opens the gate by the successful face authentication may be provided.

The registration unit 103 photographs a face image of a companion (e.g., by a camera of an authentication terminal installed in the venue), registers the photographed face image of the companion in association with the ticket for the group, and permits the entrance of the companion. As a result, the entrance management system can manage the face image of the companion in association with the face image of the representative of the group ticket.

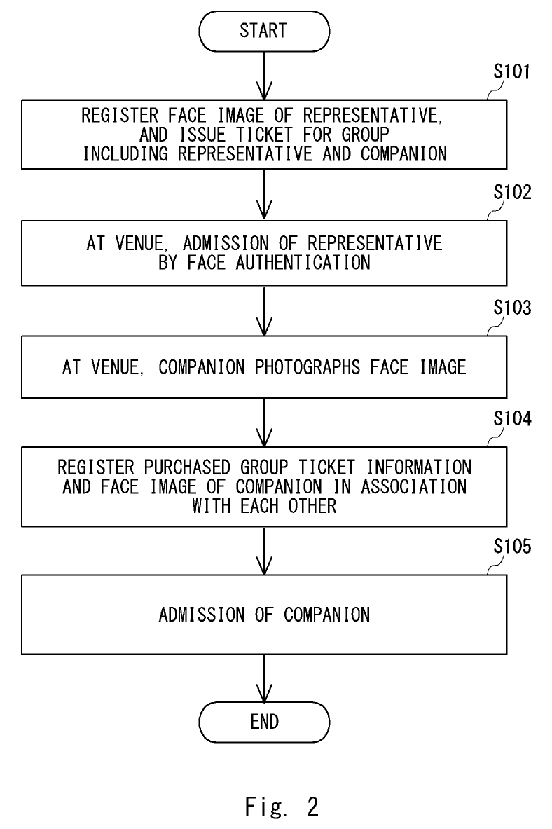

Next, an entrance management method according to the present disclosure will be described with reference to FIGS. 2 to 6.

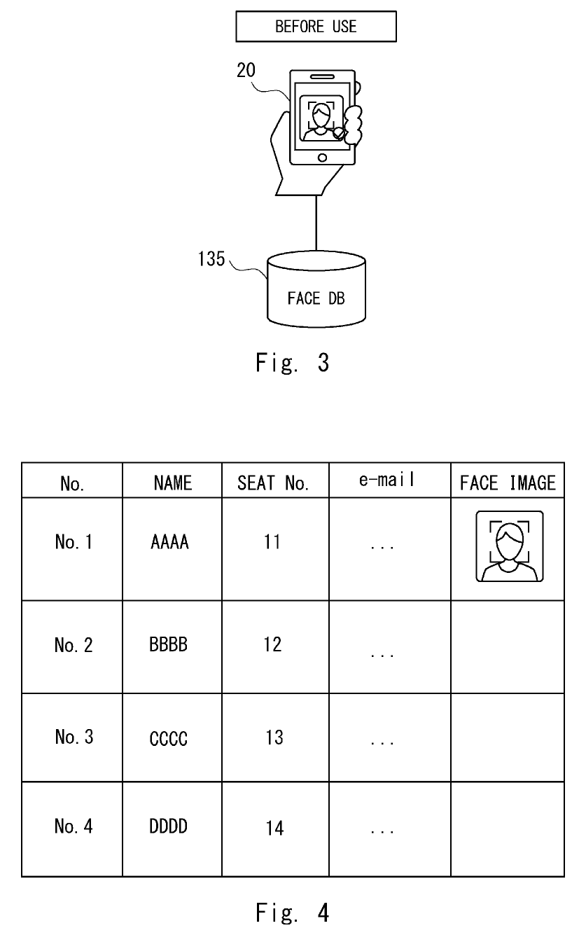

FIG. 2 is a flowchart illustrating an entrance management method according to the present disclosure. FIG. 3 is a diagram illustrating a procedure in which a representative registers his/her own face image according to the present disclosure.

As illustrated in FIG. 3, the representative registers his/her face image (in a face database 135 of the entrance management system 1) using his/her user terminal 20. The user terminal 20 may be various electronic devices such as a smartphone, a tablet, and a computer. In a case where the representative performs a procedure for purchasing a ticket for a group including the representative and the companion via user terminal 20, the ticket selling system of the entrance management system issues the ticket for the group including the representative and the companion (S101).

FIG. 4 is a diagram describing an example of group ticket information.

The group ticket information includes representative ticket information indicated by No. 1 and companion ticket information indicated by No. 2, No. 3, and No. 4. The representative ticket may include various registered matters such as a name, a seat number, an e-mail address, and a face image of the representative. The companion ticket may include various registered matters such as a name, a seat number, and an e-mail address of the companion. In some example embodiments, in the case of standing live, there may be a case where a seat number is not included in the registered matters of the ticket information. If a paper ticket is mailed, an address may be included in registered matters of the ticket information. As illustrated in the group ticket information of FIG. 4, the group ticket is issued without registering the face image of the companion. Each of the representative and each companion can acquire a ticket (e.g., a paper ticket or an e-ticket) related to the issued ticket information. As a result, the representative does not need to collect and register the face images of all the companions.

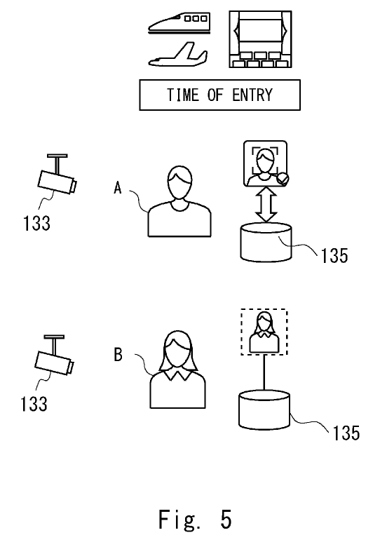

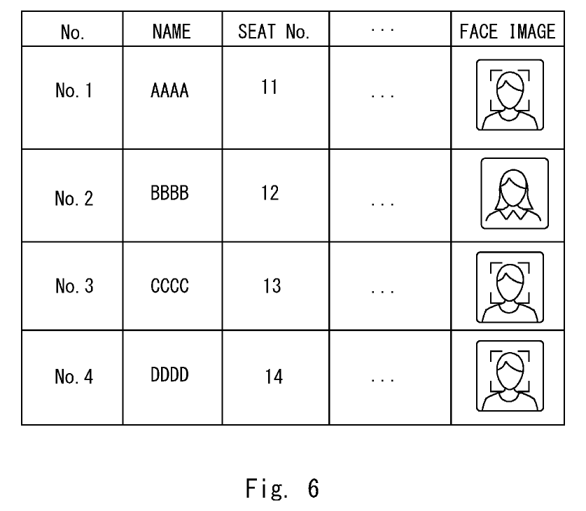

FIG. 5 is a diagram describing a procedure at the time of entry of the representative and the companion.

At the event venue or the transportation means, the representative (A in FIG. 5) performs identification confirmation of the representative by face authentication (by the camera 133 of the authentication terminal), and if the authentication is successful, the representative is permitted to enter (S102). Specifically, his/her face image the representative registered in advance is verified with the face image photographed by the camera 133, and in a case where the face images match, the face authentication is successful. The representative may or may not present the ticket at the time of entry. According to the ticket presentation method, an identification code (e.g., a QR code (registered trademark)) and a face image can be displayed on a smartphone. Through the face authentication, validity of the group ticket (including the representative ticket) purchased by the representative can be confirmed.

Returning to FIG. 3 again, at the venue or the transportation means, the companion (B in FIG. 5) self-reports that he/she is a companion of the representative (A in FIG. 5) or presents a companion ticket, and photographs the face of the companion with the camera 133 of the authentication terminal (S103). FIG. 5 illustrates an example in which the representative A and the companion B enter simultaneously, but do not necessarily need to enter simultaneously. For example, one or more companions may present a companion ticket and enter late.

The photographed face image of the companion is registered in association with the ticket for the group (in the face database 135) (S104). FIG. 6 illustrates an example in which the face image of the representative and the face images of all the companions are registered in association with the group ticket. The table of FIG. 6 illustrates an example in which the face images of the representative and the face images of all the companions are associated, and may be associated by other methods that can be understood by those skilled in the art. Thereafter, the companion is permitted to enter (S105).

In the entrance management system described above, it is not necessary for the representative to collect face images of all the members of the group in advance and associate not only the face image of the representative him/herself but also the face information of the companion with the ticket. According to the entrance management system, it is possible to relatively easily issue a group ticket while securing validity of the ticket by registering a face image of a representative. In addition, by registering the face image of the companion at the time of admission, it is possible to manage the entrants in the venue, and it is possible to exclude or suppress the group for reselling the ticket.

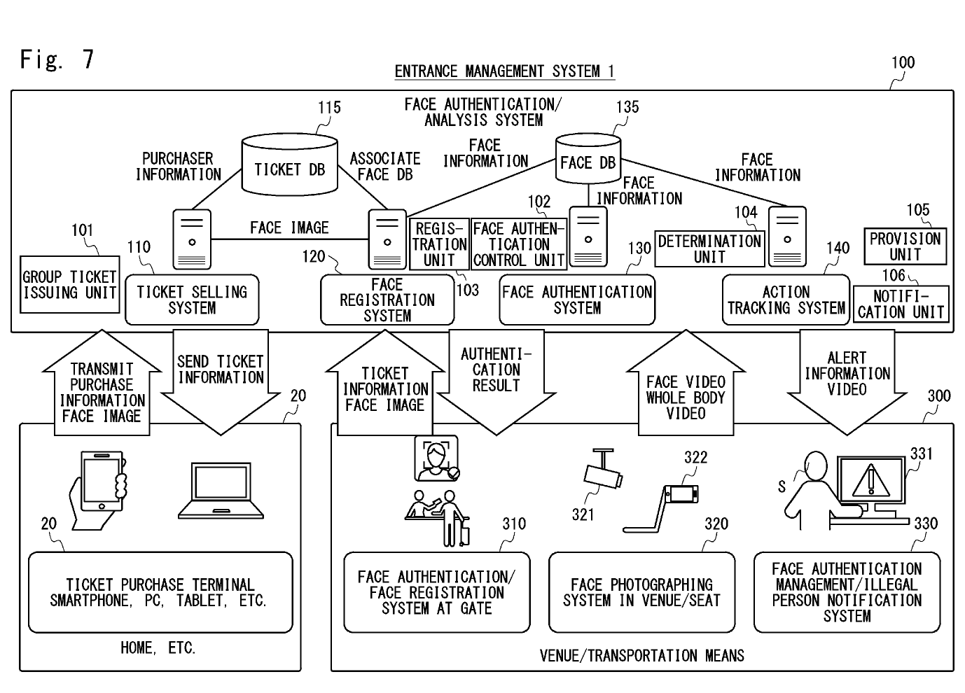

FIG. 7 is a diagram describing a configuration and an operation of the entrance management system according to the present disclosure.

The entrance management system 1 includes a face authentication/analysis system 100, a user terminal 20, and a venue or transportation means system 300.

The face authentication/analysis system 100 may include a ticket selling system 110, a ticket database 115, a face registration system 120, a face authentication system 130, a face database 135, and an action tracking system 140. In addition, the face authentication/analysis system 100 includes several functional processing units. That is, the face authentication/analysis system 100 can include some or all of the group ticket issuing unit 101, the face authentication control unit 102, the registration unit 103, a determination unit 104, a providing unit 105, and a notification unit 106. Details thereof will be described below.

The user terminal 20 is a terminal used to purchase a ticket at home or the like, and may be, for example, an electronic terminal such as a smartphone, a personal computer, or a tablet. In particular, in order to display the e-ticket at the time of entry, the user terminal 20 may be a mobile terminal such as a smartphone or a tablet. The user terminal 20 can transmit the ticket purchase information and the face image to the ticket selling system 110, and can receive the ticket information from the ticket selling system 110.

The ticket database 115 stores purchaser information (e.g., information regarding a representative and a companion.) acquired via the user terminal 20. The face registration system 120 (registration unit 103) registers, in the face database 135, the face image of the representative acquired via the user terminal 20 and the face image of the companion acquired via the camera of the authentication terminal at the venue. The ticket selling system 110 (group ticket issuing unit 101) issues a group ticket after a ticket purchase procedure by the representative is completed. The group ticket may include a representative ticket indicating representative information (e.g., the name of the representative, etc.) and a companion ticket indicating companion information (e.g., the name of the companion). The representative ticket can be displayed by the user terminal of the representative, and the companion ticket can be displayed by the user terminal of the companion. In some examples, after a ticket purchase procedure by the representative and issuance of a group ticket, a face image of a representative may be registered and the face image of the representative may be associated with representative information of the group ticket.

The venue or transportation means system 300 monitors and tracks the representative and the companion with one or more cameras in the venue or the like. The venue or transportation means system 300 may include various terminals (e.g., an authentication terminal, a camera, a notification means) installed in the event venue. In addition, in some example embodiments, various terminals installed in transportation means such as an airplane, a bullet train, and a passenger boat may be included. As illustrated in FIG. 7, the venue or transportation means system 300 may include a face authentication and face registration system 310 at a gate, a face photographing system 320 in the venue and at a seat, and a face authentication management and illegal person notification system 330.

The face authentication and face registration system 310 at the gate requests the face authentication system 130 to perform the face authentication based on the face image (and the ticket information) of the representative photographed by the camera of the authentication terminal. In some examples, a representative can provide ticket information of the representative by causing a reader to read ticket information (e.g., a QR code) displayed on his/her user terminal. The face authentication and face registration system 310 at the gate controls opening/closing of the gate according to the face authentication result of the representative. The face authentication and face registration system 310 at the gate transmits a face image (and ticket information) of the companion photographed by the camera of the authentication terminal to the face registration system 120(e.g., the registration unit 103) and requests for registration. In some examples, a companion can provide ticket information of the companion by causing a reader to read ticket information (e.g., a QR code) displayed on his/her user terminal. In addition, the face authentication and face registration system 310 at the gate can open the gate and permit the companion to enter after the registration of the face image of the companion is completed.

As a result, in the group ticket purchased by the representative, the face image of the representative and the face image of the companion can be registered in association with each other, so that appropriate entrants management can be executed, and the group for reselling purpose can be suppressed or excluded.

Next, the monitoring of the entrants and the illegal person notification after entering will be described.

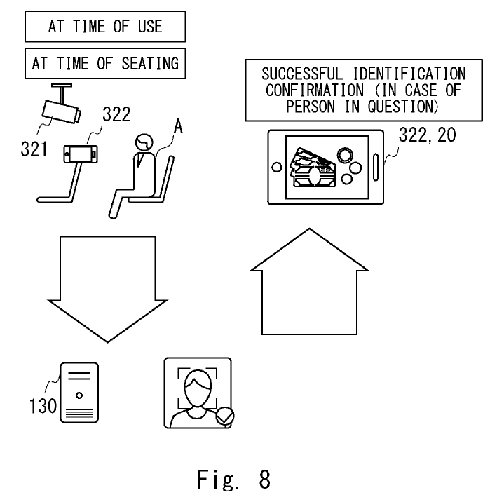

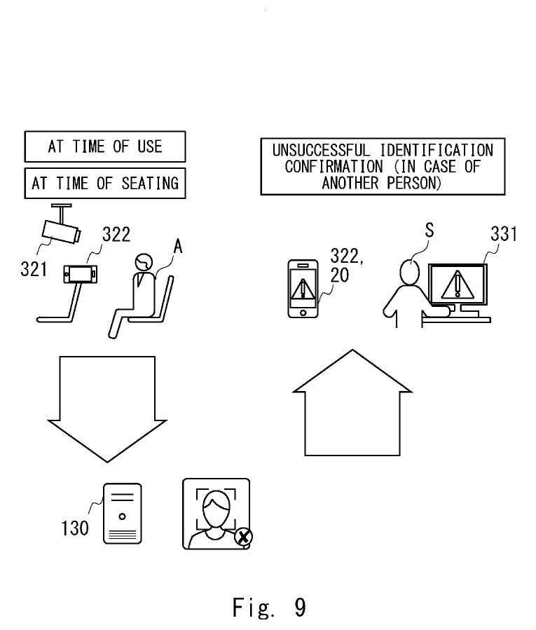

FIG. 8 is a diagram describing face authentication processing (successful identification confirmation) in a venue and a seat. FIG. 9 is a diagram describing face authentication processing (unsuccessful identification confirmation) in a venue and a seat. The face photographing system 320 in the venue and the seat photographs the face images of the representative and the companion using the camera 321 installed in the venue and the camera-equipped terminal 322 installed in each seat, and executes the identification confirmation in cooperation with the face authentication system 130. The face authentication system 130 (the face authentication control unit 102 and the determination unit 104) verifies the face image of the representative registered in the face database 135 with the face image of the representative photographed by the camera-equipped terminal 322 installed in the seat, and can determine as successful face authentication if the face images match with each other. Furthermore, whether the seat on which the representative is seated matches the seat of the representative indicated in the group ticket (e.g., seat No. 11 in FIG. 6) can be determined.

Similarly, the face authentication system 130 (the face authentication control unit 102 and the determination unit 104) verifies the face image of the companion registered in the face database 135 with the face image of the companion photographed by the camera-equipped terminal 322 installed in the seat, and can determine as successful face authentication if the face images match. In addition, whether the seat on which the companion is seated matches the seat of the companion indicated in the group ticket (e.g., seats No. 12, No. 13, and No. 14 in FIG. 6) can be determined.

As a result, it is possible to confirm whether the representative and the companion are seated in the designated seat of the purchased ticket. It is possible to prevent the entrants from sitting on another vacant seat (e.g., a more expensive seat) without permission.

Furthermore, the determination unit 104 can determine whether the group is appropriate based on the respective consecutive images (the face image and the whole-body image) photographed by the representative and the companion. For example, as an example of an inappropriate group, a representative may purchase a group ticket and sell a companion ticket to another person at a high price. The determination of an appropriate group is as follows. Determination is made based on whether a ticket purchaser (representative) is at a designated seat or a seat in the vicinity of a seat of a companion. For example, in a case where the companion is not seated on the designated seat or is seated on a seat spaced apart from the seat of the companion by a certain distance or more, determination can be made that the possibility of being an inappropriate group is high. Furthermore, determination may be made based on whether the companion enters the venue at substantially the same time as the representative and arrives at the seat. In a case where the companion enters the venue at a time different from that of the representative and arrives at the seat, determination can be made that there is a high possibility of being an inappropriate group. Furthermore, face authentication and tracking of a companion may be performed after seating, and determination may be made based on whether the companion is performing the same action as the representative (purchaser of the group ticket) after seating. Examples of the action referred to herein include, but are not limited to, going to a toilet, leaving the venue, shopping at a store, a representative and a companion facing each other and having a conversation, a representative assisting the companion (giving drinks, helping in seating, etc.), and the like. As a result of determining the actions of the companion and the representative, in a case where the companion and the representative clearly take separate actions, determination can be made that there is a high possibility of being an inappropriate group.

In this manner, the face photographing system 320 in the venue and the seat tracks the actions of the representative and the companion of the group ticket in cooperation with the action tracking system 140, and can analyze and determine the relationship between the representative and the companion. For example, if the representative and the companion act separately and do not have a conversation at all, determination can be made that the representative and the companion are not related persons (the relationship between the representative and the companion is inappropriate). That is, it can be determined that there is a possibility that the ticket had been resold.

The determination unit 104 can also determine the validity of the companion ticket.

In the case of a ticket (ticket for infant, elementary school student, etc.) with age limit (e.g., 18 years of age or older), whether a companion is a child may also be determined based on a face and a whole-body image (height/face position, etc.) photographed by a camera of an authentication terminal at the time of entry or a camera in a venue. In the case of a ticket (ticket for an elderly person) with age limit (e.g., 60 years of age or older), whether a companion is an elderly person may also be determined based on a photographed face and whole-body image (facial wrinkles, head hair, cane, etc.). Furthermore, in the case of a ticket for accompanying a disabled person, whether the companion is a disabled person may also be determined based on the photographed face and whole-body image (wheelchair, cane, etc.).

As illustrated in FIG. 8, in a case where the entrants cooperate with the identification confirmation and the identification confirmation is successful (in a case where the person of the ticket is seated on a predetermined seat), the providing unit 105 of the entrance management system 1 may provide a service (privilege) such as a point or free drink to the camera-equipped terminal 322 installed on the seat or user terminal 20 as a gratitude for the cooperation.

On the other hand, as illustrated in FIG. 9, in a case of unsuccessful identification confirmation (in a case where another person is seated on a predetermined seat), the notification unit 106 of the entrance management system 1 may notify that an inappropriate person has entered or is seated to the communication terminal 331 used by the staff S of the event venue or the transportation means, together with a video obtained by photographing the seat information. As a method of notifying such an alert, various visual or auditory methods can be used. Alternatively, the user terminal 20 of the representative of the ticket or the camera-equipped terminal 322 installed in the seat may be notified of the identification confirmation request. The communication terminal 331 may be any suitable communication terminal such as a smartphone, a tablet, or a personal computer.

### Other Example Embodiments

The getting-on of the child may be detected based on the photographed image by the camera installed in the transportation means, and the getting-on of the child may be notified to the parent. As a notification method, not only with the e-mail sentence or the photographed still image, but also the state in the venue and the vehicle can be viewed as a moving image from the smartphone if desired by the parent. The parent can see what the child is doing in a moving image via the terminal. Since the face authentication is performed, tracking can be performed even if the user leaves the seat in the vehicle or the venue. The notification to the parent may be made at the timing of leaving the seat.

A lottery event may be performed with the entrance management system according to the present disclosure. The person who has performed the face registration may be set as a target of the lottery event, and the lottery may be held for the people seated in the venue. At the time of winning, the state of the seat is projected on a large monitor, so that the winning is notified and a present is given.

In the entrance management system according to the present disclosure, a monitor may be installed in the transportation means. For example, a monitor can be installed on the front side of a first-class seat or a high-class seat of an airplane or a bullet train. In accordance with the situation of the face authentication, a privilege such as additionally distributing miles for airplanes and points for the bullet train or enabling viewing of special content (e.g., a latest movie or game) on the monitor may be granted. My Page may be displayed on the monitor according to the face authentication by the camera in front of the seat. In a case where one boards with the face authentication, it is possible to view content on the monitor customized for each individual after seating.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely illustrative for describing one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing exemplary example embodiments are not necessarily mandatory, and some features or steps may be omitted. The order of the steps described in any of the drawings may be appropriately changed.

In the above-described example, the program includes instructions (or software code) for causing a computer to perform one or more functions described in the example embodiment in the case of being read by the computer. The program may be retained in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer-readable medium or a communication medium. As an example and not by way of limitation, the transitory computer-readable medium or the communication medium includes an electric, optical, acoustic, or another form of propagated signal.

Some or all of the example embodiments described above may also be described as, but are not limited to, the following Supplementary Notes.

### Supplementary Note 1

An entrance management system including

a group ticket issuing unit for registering a face image of a representative and issuing a ticket of a group including the representative and a companion,

a face authentication control unit for photographing a face image of the representative, executing face authentication based on the photographed face image of the representative and the registered face image, and permitting the representative to enter in successful face authentication, and

a registration unit for photographing a face image of the companion, registering the photographed face image of the companion in association with a ticket of the group, and permitting the companion to enter.

### Supplementary Note 2

The entrance management system according to supplementary note 1, further including

the group ticket issuing unit for registering a face image of a representative via a user terminal of the representative and issuing a ticket of a group including the representative and a companion,

the face authentication control unit for photographing a face image of the representative by a camera-equipped authentication terminal installed at an event venue or an entrance of a transportation means, executing face authentication based on the photographed face image of the representative and the registered face image, and permitting the representative to enter by a gate installed at the entrance of the event venue or the transportation means in successful face authentication, and

the registration unit for photographing a face image of the companion by the camera-equipped authentication terminal installed at the event venue or the entrance of the transportation means, registering the photographed face image of the companion in association with a ticket of the group, and permitting the companion to enter by a gate installed at the event venue or the entrance of the transportation means.

### Supplementary Note 3

The entrance management system according to supplementary note 1, in which

the ticket information of the group includes seat information of the representative or the companion,

a representative or a companion seated on the seat is photographed by a camera installed at an event venue or a transportation means, or a camera-equipped terminal installed in a seat of the event venue or the transportation means, and

a determination unit for executing face authentication based on the photographed image of the representative or the companion and a registered face image of the representative or the companion, performing identification confirmation of whether a person seated on a seat is the representative or the companion, and determining whether the seat on which the representative or the companion is seated matches seat information of the representative or the companion indicated in the ticket information of the group is further provided.

### Supplementary Note 4

The entrance management system according to supplementary note 3, further including a providing unit for providing, in a case where a person seated on the seat of the representative or the companion is the representative or the companion and the seat on which the representative or the companion is seated matches seat information of the representative or the companion indicated in the ticket information of the group according to a face authentication result, a privilege for the representative or the companion to a user terminal of the representative or the companion or the camera-equipped terminal installed on the seat of the representative or the companion.

### Supplementary Note 5

The entrance management system according to supplementary note 3, further including a notification unit for notifying, in a case where a person seated on the seat of the representative or the companion is not the representative or the companion and the seat on which the representative or the companion is seated does not match seat information of the representative or the companion indicated in the ticket information of the group according to a face authentication result, an alert to a communication terminal used by a staff of the event venue or the transportation means or a user terminal of the representative or the companion.

### Supplementary Note 6

The entrance management system according to supplementary note 3, further including

a determination unit for determining whether a relationship between the representative and the companion is an appropriate group based on an image of the representative and the companion photographed by a camera installed in the event venue or the transportation means or a camera-equipped terminal installed in a seat of the event venue or the transportation means, and

a notification unit for notifying an alert in a case where determination is made that the representative and the companion are not an appropriate group.

### Supplementary Note 7

The entrance management system according to supplementary note 2, further including

a determination unit for determining, in a case where there is age limit or disabled person limit in the issued group ticket, whether the companion conform to the age limit or the disabled person limit in the ticker of the group based on an image of the companion photographed by a camera installed in the event venue or the transportation means or a camera-equipped terminal installed in a seat of the event venue or the transportation means, and

a notification unit for notifying, in a case where the companion does not conform to the age limit or the disabled person limit of the ticket of the group, an alert to a communication terminal used by a staff of the event venue or the transportation means.

### Supplementary Note 8

An entrance management method including

registering a face image of a representative and issuing a ticket of a group including the representative and a companion,

photographing a face image of the representative, executing face authentication based on the photographed face image of the representative and the registered face image, and permitting the representative to enter in successful face authentication, and

photographing a face image of the companion, registering the photographed face image of the companion in association with a ticket of the group, and permitting the companion to enter.

### Supplementary Note 9

A program for causing a computer to execute

registering a face image of a representative and issuing a ticket of a group including the representative and a companion,

photographing a face image of the representative, executing face authentication based on the photographed face image of the representative and the registered face image, and permitting the representative to enter in successful face authentication, and

photographing a face image of the companion, registering the photographed face image of the companion in association with a ticket of the group, and permitting the companion to enter.

Some or all of the elements (e.g. configurations and functions) described in Supplementary Notes 2 to 7 depending from Supplementary Note 1 may depend on Supplementary Notes 8 and 9 as well with depending relationships similar to those of Supplementary Notes 2 to 7. Some or all of the elements described in any supplementary note can be applied to various types of hardware, software, recording means for recording software, systems, and methods.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An entrance management system comprising:
at least one memory storing instructions, and
at least one processor configured to execute the instructions to:
register a face image of a representative and issuing a ticket of a group including the representative and a companion;
photograph a face image of the representative, executing face authentication based on the photographed face image of the representative and the registered face image, and permitting the representative to enter in successful face authentication; and
photograph a face image of the companion, registering the photographed face image of the companion in association with a ticket of the group, and permitting the companion to enter.

2. The entrance management system according to claim 1, wherein the at least one processor is further configured to execute the instructions to: register a face image of a representative via a user terminal of the representative and issuing a ticket of a group including the representative and a companion;
photograph a face image of the representative by a camera-equipped authentication terminal installed at an event venue or an entrance of a transportation means, execute face authentication based on the photographed face image of the representative and the registered face image, and permitting the representative to enter by a gate installed at the entrance of the event venue or the transportation means in successful face authentication; and
photograph a face image of the companion by the camera-equipped authentication terminal installed at the event venue or the entrance of the transportation means, register the photographed face image of the companion in association with a ticket of the group, and permit the companion to enter by a gate installed at the event venue or the entrance of the transportation means.

3. The entrance management system according to claim 1, wherein
the ticket information of the group includes seat information of the representative or the companion,
wherein the at least one processor is further configured to execute the instructions to photograph a representative or a companion seated on the seat is with a camera installed at an event venue or a transportation means, or a camera-equipped terminal installed in a seat of the event venue or the transportation means, and
execute face authentication based on the photographed image of the representative or the companion and a registered face image of the representative or the companion, performing identification confirmation of whether a person seated on a seat is the representative or the companion, and determine whether the seat on which the representative or the companion is seated matches seat information of the representative or the companion indicated in the ticket information of the group is further provided.

4. The entrance management system according to claim 3, wherein the at least one processor is further configured to execute the instructions to provide, in a case where a person seated on the seat of the representative or the companion is the representative or the companion and the seat on which the representative or the companion is seated matches seat information of the representative or the companion indicated in the ticket information of the group according to a face authentication result, a privilege for the representative or the companion to a user terminal of the representative or the companion or the camera-equipped terminal installed on the seat of the representative or the companion.

5. The entrance management system according to claim 3, wherein the at least one processor is further configured to execute the instructions to notify, in a case where a person seated on the seat of the representative or the companion is not the representative or the companion and the seat on which the representative or the companion is seated does not match seat information of the representative or the companion indicated in the ticket information of the group according to a face authentication result, an alert to a communication terminal used by a staff of the event venue or the transportation means or a user terminal of the representative or the companion.

6. The entrance management system according to claim 3, wherein the at least one processor is further configured to execute the instructions to determine whether a relationship between the representative and the companion is an appropriate group based on an image of the representative and the companion photographed by a camera installed in the event venue or the transportation means or a camera-equipped terminal installed in a seat of the event venue or the transportation means; and
notify an alert in a case where determination is made that the representative and the companion are not an appropriate group.

7. The entrance management system according to claim 2, wherein the at least one processor is further configured to execute the instructions to determine, in a case where there is age limit or disabled person limit in the issued group ticket, whether the companion conforms to the age limit or the disabled person limit in the ticket of the group based on an image of the companion photographed by a camera installed in the event venue or the transportation means or a camera-equipped terminal installed in a seat of the event venue or the transportation means; and
notify, in a case where the companion does not conform to the age limit or the disabled person limit of the ticket of the group, an alert to a communication terminal used by a staff of the event venue or the transportation means.

8. An entrance management method comprising:
registering a face image of a representative and issuing a ticket of a group including the representative and a companion;
photographing a face image of the representative, executing face authentication based on the photographed face image of the representative and the registered face image, and permitting the representative to enter in successful face authentication; and
photographing a face image of the companion, registering the photographed face image of the companion in association with a ticket of the group, and permitting the companion to enter.

9. A non-transitory computer-readable medium stored with a program for causing a computer to execute:
registering a face image of a representative and issuing a ticket of a group including the representative and a companion;
photographing a face image of the representative, executing face authentication based on the photographed face image of the representative and the registered face image, and permitting the representative to enter in successful face authentication; and
photographing a face image of the companion, registering the photographed face image of the companion in association with a ticket of the group, and permitting the companion to enter.
